(19) United States
(12) Patent Application Publication
(10) Pub. No.: US 2016/0277846 A1
(43) Pub. Date: Sep. 22, 2016

(54) ACOUSTIC DEVICE WITH ONE OR MORE TRIM CAPACITORS

(71) Applicant: Knowles Electronics, LLC, Itasca, IL (US)

(72) Inventor: Sung B. Lee, Chicago, IL (US)

(73) Assignee: Knowles Electronics, LLC, Itasca, IL (US)

(21) Appl. No.: 15/071,757

(22) Filed: Mar. 16, 2016

Related U.S. Application Data
(60) Provisional application No. 62/135,804, filed on Mar. 20, 2015.

(51) Int. Cl. H04R 19/04; H04R 1/04

(52) U.S. Cl. CPC H04R 19/04; H04R 1/04; H04R 2201/003

(57) ABSTRACT

An acoustic device includes a substrate that has a port. The acoustic device further includes a microelectromechanical system (MEMS) that converts sound energy into electrical energy. The MEMS is attached to the substrate over the port. An application specific integrated circuit (ASIC) is connected to the MEMS via a first electrical path. A first capacitor is connected to the first electrical path decreasing the sensitivity of the MEMS.

### CROSS-REFERENCE TO RELATED APPLICATIONS

This application claims the benefit of and priority to U.S. Provisional Application No. 62/135,804, filed Mar. 20, 2015, the entire contents of which is incorporated by reference in its entirety.

### TECHNICAL FIELD

This application relates to acoustic devices and, more specifically, to acoustic devices with enhanced performance characteristics.

### BACKGROUND OF THE INVENTION

Various types of microphones and receivers have been used through the years. In these devices, different electrical components are housed together within a housing or assembly. Other types of acoustic devices may include other types of components. These devices may be used in hearing instruments such as hearing aids, personal audio headsets, or in other electronic devices such as cellular phones and computers.

Microphones are typically composed of two main components: Microelectromechanical System (MEMS) elements that receive and convert the sound into electrical signal, and Application Specific Integrated Circuits (ASICs) that take the electrical signal from the MEMS devices and perform post processing on the signal and/or buffer the signal for the following circuit stages in a larger electronic environment. In one example, the ASIC performs pre-amplification functions for other circuits.

Sensitivity refers to the signal level processed by the ASIC originating from sound pressure. In many cases, it is desired to optimize the sensitivity of the microphone. For example, in some circumstances it is desired to have a relatively great sensitivity. However, in other circumstances it is better to have a relatively small sensitivity. Previous attempts at addressing these concerns have not been successful. Consequently, some user dissatisfaction has developed concerning these previous approaches.

### BRIEF DESCRIPTION OF THE DRAWINGS

For a more complete understanding of the disclosure, reference should be made to the following detailed description and accompanying drawings wherein:

FIG. 1A comprises an electrical diagram of an acoustic device with a trim capacitor according to various embodiments of the present invention;

FIG. 1B cross-sectional view of a microphone with a trim capacitor built in according to various embodiments of the present invention;

FIG. 2 comprises a connection diagram for a microphone with one potential capacitor according to various embodiments of the present invention;

FIG. 3 comprises a connection diagram for a microphone with one potential capacitor according to various embodiments of the present invention;

FIG. 4 comprises a connection diagram for a microphone with one potential capacitor according to various embodiments of the present invention;

FIG. 5 comprises a connection diagram for a microphone with two potential capacitors according to various embodiments of the present invention;

FIG. 6 comprises a connection diagram for a microphone with two potential capacitors according to various embodiments of the present invention;

FIG. 7 comprises a connection diagram for a microphone with two potential capacitors according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

In the approaches described herein, one or more capacitors are added to an acoustic device (e.g., a microphone) at the time of manufacturing to trim (or limit or optimize) the performance of the acoustic device. In one aspect, the addition of the capacitor (or capacitors) brings the sensitivity of the device to a desired level. High sound pressure signals can be handled while maintaining linear device performance. By “capacitor” and as used herein it is meant one or more capacitors. For instance, a single capacitor can be used, or two or more capacitors arranged in any electrical configuration (serial or parallel) or combinations of configurations.

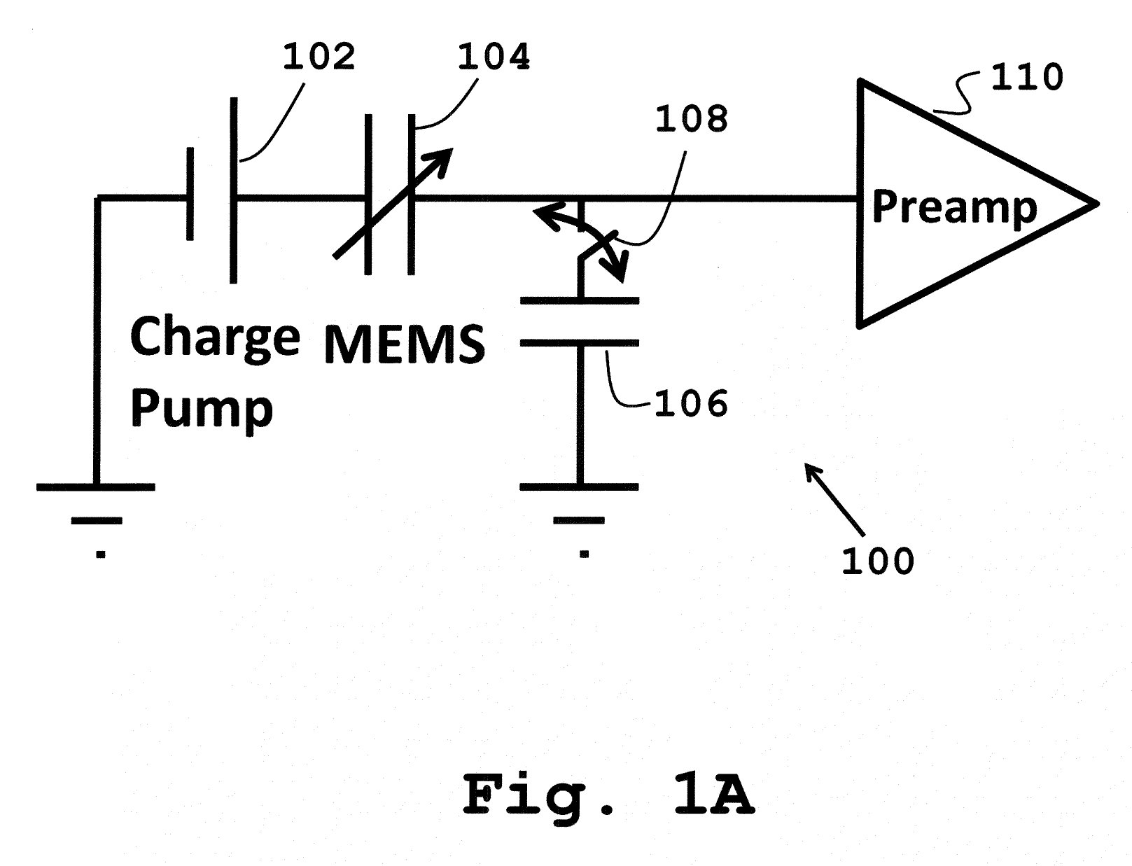

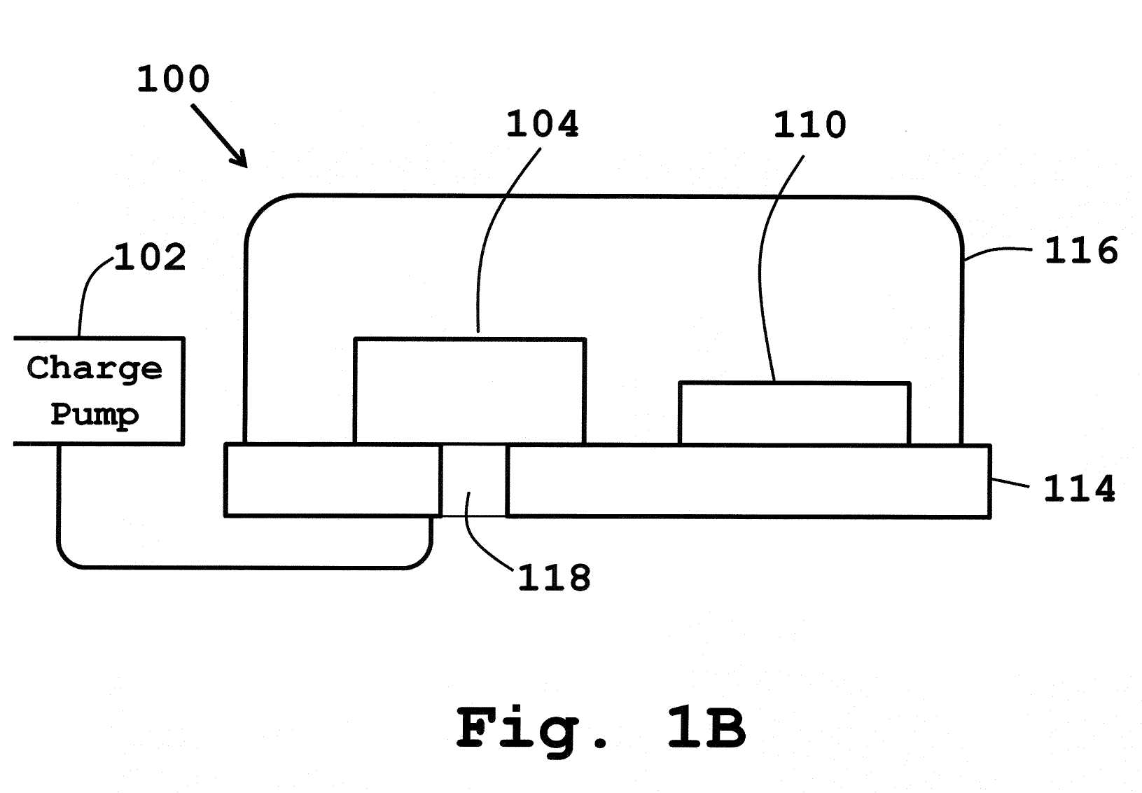

Referring now to FIGS. 1A and 1B, one example of an acoustic device 100 that utilizes one or more trim capacitors is described. The acoustic device 100 includes a charge pump 102, a microelectromechanical system (MEMS) device 104, a capacitor 106 that is connected into the circuit by a switching arrangement 108, and a preamplifier 110.

The charge pump 102 may be a current or voltage source that supplies a current or voltage to the MEMS device 104. The MEMS device 104 includes a MEMS die, a back plate, and a diaphragm. Sound energy entering the acoustic device 100 moves the diaphragm. Together with the back plate, this action creates an electrical current/voltage and this electrical current and voltage can be supplied to the preamplifier 110. The preamplifier 110 may be any type of ASIC or other type of integrated circuit that performs any processing function.

One or more trim capacitors 106 may be included in the circuit. The switching arrangement 108 may be a solder point, a wire that is added or removed, a conductive film that is present but can be disconnected, or an actual electrical switch. The capacitor 106 can be switched into or out of the circuit during manufacturing, after manufacturing (on-the-fly), or automatically switched in or out of the circuit using a switching device.

Capacitor 106 may be built into the ASIC 110, the MEMS 104, or disposed on the base 114 as a separate device.

In one example, the one or more trim capacitors 106 are parasitic capacitances (e.g., approximately 0.5 farads) that are introduced into the circuit to decrease sensitivity or are removed from the circuit to increase sensitivity.

In one aspect, the one or more capacitors are connected when the diaphragm deflection is too flat and sensitivity needs to be decreased. On the other hand, the gain of the preamplifier 110 may be optimized with the one or more capacitors 106 being disconnected. In these regards, the one or more capacitors 106 are disconnected in situations, circumstances, or operating conditions where higher sensitivity is required.

Referring now to FIG. 1B, the MEMS device 104 is disposed on substrate 114 as is preamplifier 110. A cover 116 encloses the MEMS device 104 and the preamplifier 110. A port 118 allows sound energy to be sensed by the MEMS device 104 and converted into electrical energy. In one example, the capacitors 106 may be disposed on the base 114. After processing, the signal may be transmitted through the base 114 to pads where other electronic devices or circuits may couple to these pads and further use the signal.

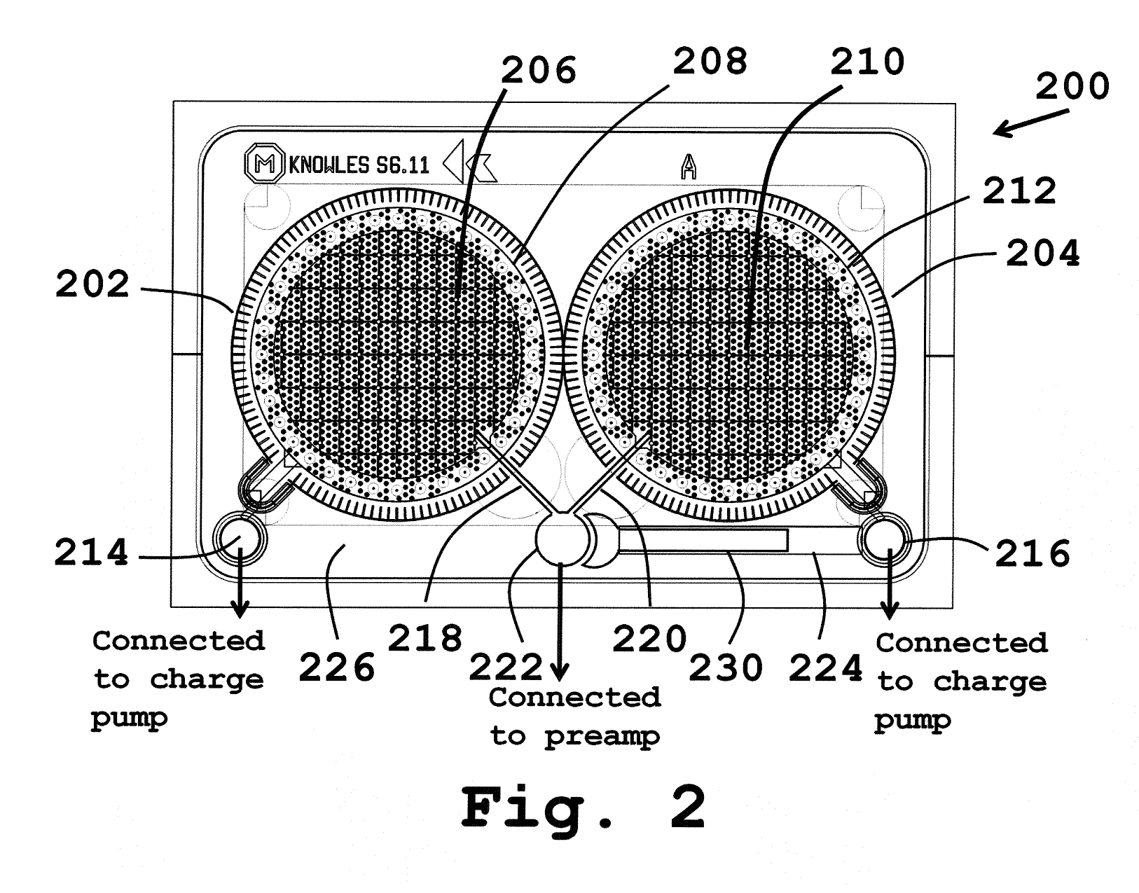

Referring now to FIGS. 2, 3, 4, 5, 6, and 7 various physical or mechanical connections of a MEMS device 200 with respect to one or more capacitors is described. The MEMS device 200 includes a first motor 202 and a second motor 204. The first motor 202 includes a first back plate 206 and a first diaphragm 208. The second motor 204 includes a second back plate 210 and a second diaphragm 212. The first motor 202 includes a pad 214 that is connected to a charge pump (not shown) and the substrate. The second motor has a pad 216 that is also connected to the substrate and the charge pump. A first connection 218 and a second connection 220 are made to a pad 222. The pad 222 electrically couples to a pre-amplifier (or some other integrated circuit or device or output). A first area 230 of the base of the acoustic device and a second area 226 of the base of the acoustic device can be used to form or hold capacitors. It will be appreciated that the configurations shown in FIGS. 2, 3, 4, 5, 6, and 7 physically implement portions of the electrical circuit of FIG. 1.

Referring now to FIG. 2, a first capacitor 230 is formed in the first area 224. This first capacitor 230 may be constructed of metal Silicon Nitride, and silicon oxide. Other materials may also be used. As shown in FIG. 2, the first capacitor 230 is unconnected to the remainder of the circuit.

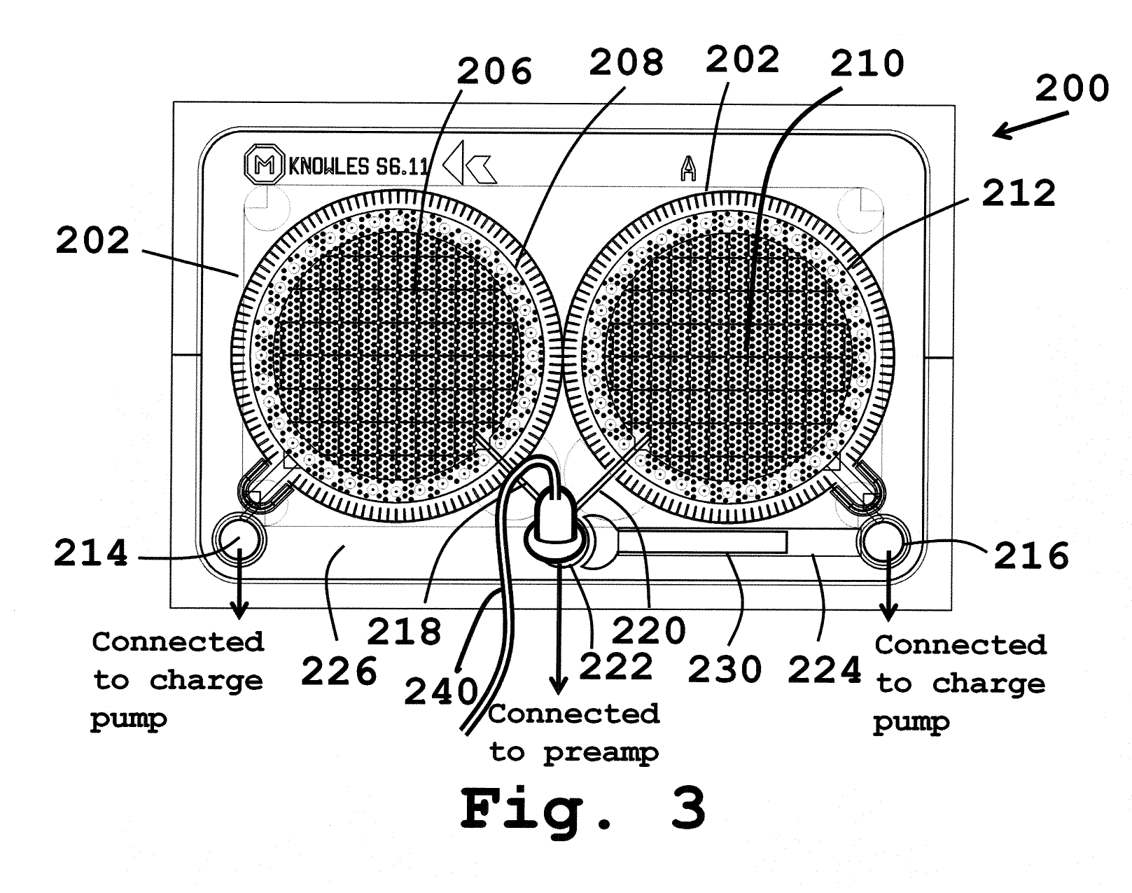

Referring now to FIG. 3, a configuration is shown where under normal conditions (where diaphragm deflections are acceptable), the back plates 206 and 210 are both connected to pad 222 and are wire bonded with wire 240 to and ASIC or other processing unit. The first capacitor 230 is not in the circuit. By wire bonded and as used herein, it is meant an electrical connection using thin wires normally used in the semiconductor industry where a ball is formed at the end of the wire and ultrasonically welded to pads (pad 222 in this case).

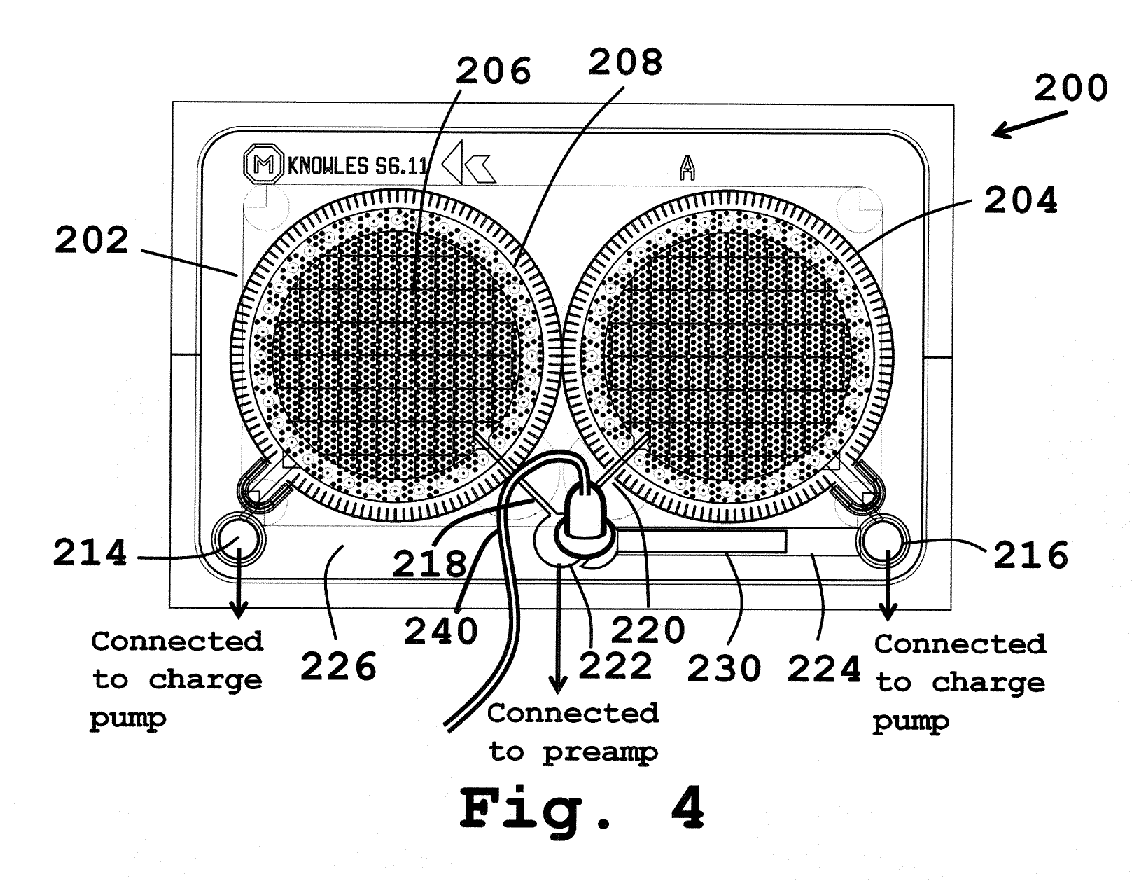

Referring now to FIG. 4, a configuration is shown where a decrease in sensitivity (e.g., a 2 dB decrease) is desired. In this case, the wire bond 240 bridges the gap between pad 222 and the capacitor 230 thereby connecting the capacitor 230 into the circuit. In this case, the wire bond 240 is made slightly to one side to couple the capacitance 230 into the circuit.

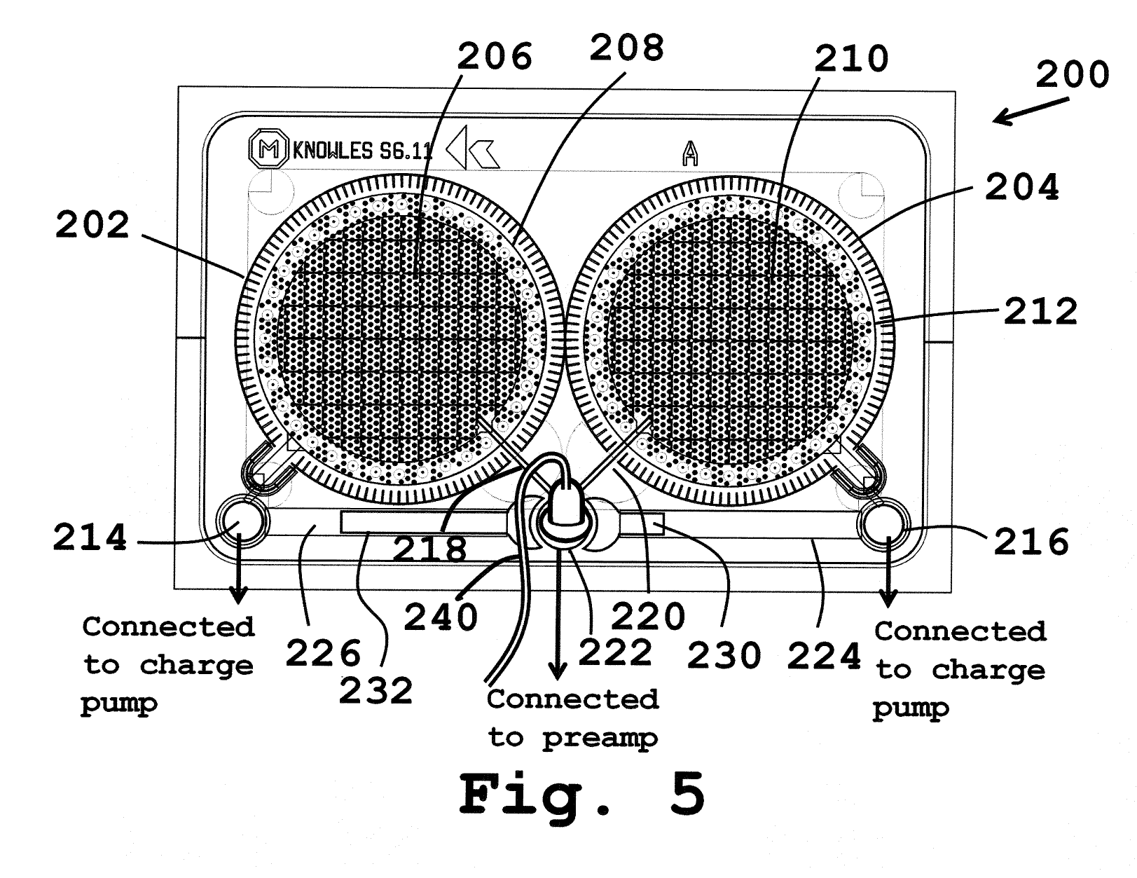

Referring now to FIG. 5, a configuration is shown where an increase in sensitivity (e.g., a 1 dB increase) is desired. In this case, the wire bond 240 does not bridge the gap between pad 222 and the first capacitor 230 or between pad 222 and a second capacitor 232. In this case, the diaphragm deflection is too large and the nominal sensitivity needs to be increased.

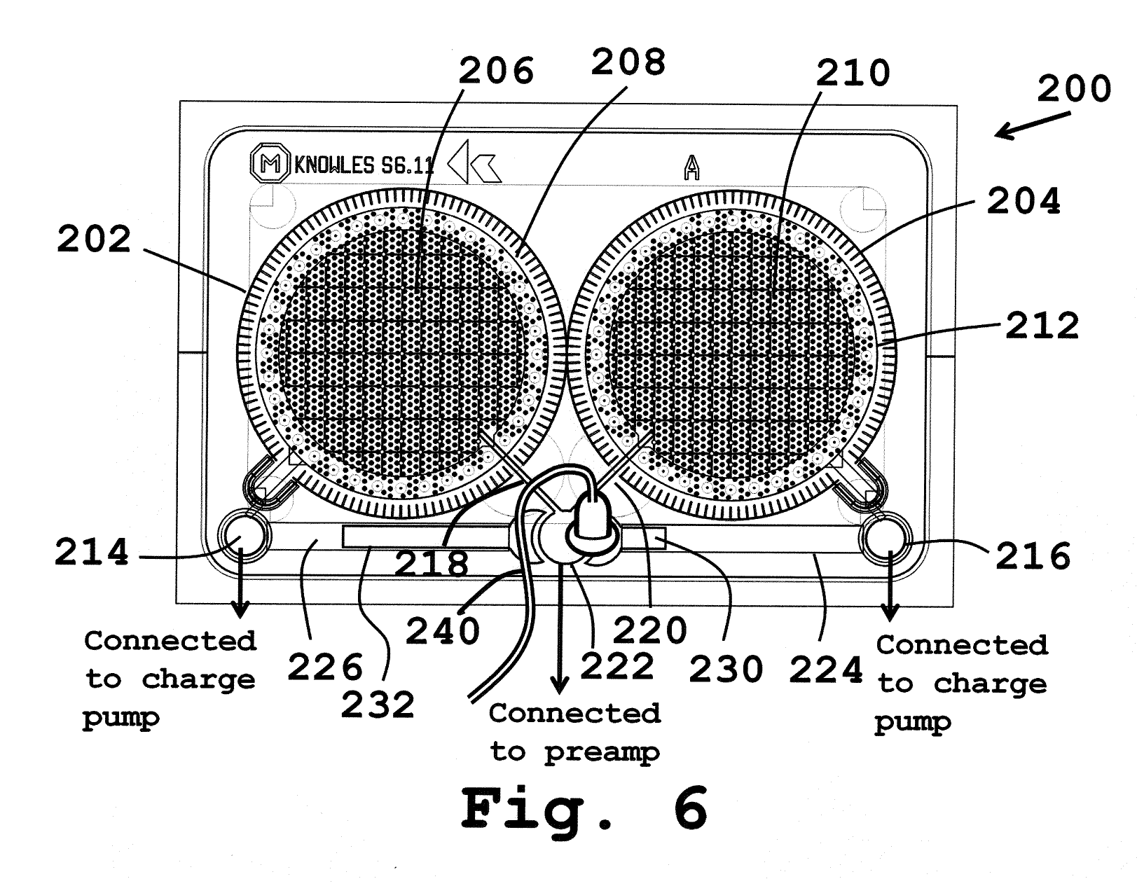

Referring now to FIG. 6, a configuration is shown where a decrease in sensitivity is desired. In this case, the wire bond 240 bridges the gap between pad 222 and the first capacitor 230 but does not bridge the gap to connect a second capacitor 232 with the pad 222. In this case, the first capacitor 230 is smaller in value than the second capacitor 232. It is desired to optimize ASIC performance and the smaller valued capacitor 230 is added to the circuit.

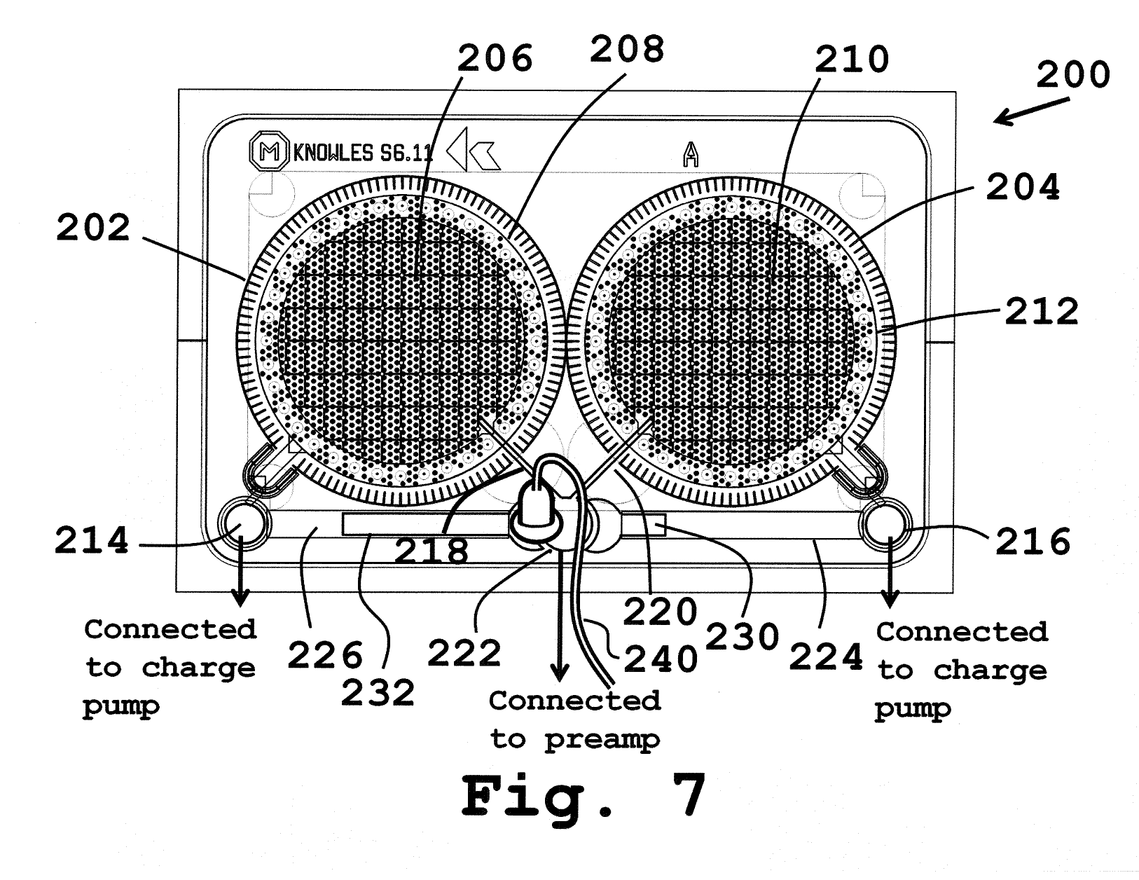

Referring now to FIG. 7, a configuration is shown where a decrease in sensitivity (e.g., a 1 dB decrease) is desired. In this case, the wire bond 240 does not bridge the gap between pad 222 and the first capacitor 230 but does bridge the gap to connect to the second capacitor 232. In this case, the first capacitor 230 is smaller in value than the second capacitor 232. It is desired to wire bond the circuit to a larger capacitor to decrease the sensitivity of the microphone.

Preferred embodiments of this invention are described herein, including the best mode known to the inventors for carrying out the invention. It should be understood that the illustrated embodiments are exemplary only, and should not be taken as limiting the scope of the invention.

1. An acoustic device comprising:
a substrate having a port;
a microelectromechanical system (MEMS) that converts sound energy into electrical energy and is attached to the substrate over the port;
an application specific integrated circuit (ASIC) operably connected to the MEMS via a first electrical path; and
a first capacitor operably connected to the first electrical path decreasing the sensitivity of the MEMS.

2. The acoustic device of claim 1, further comprising a charge pump operably connected to the MEMS.

3. The acoustic device of claim 1, wherein the MEMS is a microphone.

4. The acoustic device of claim 1, wherein the ASIC comprises a preamplifier.

5. The acoustic device of claim 1, further comprising a switch that is configured to disconnect the first capacitor from the first electrical path.

6. The acoustic device of claim 1, wherein the MEMS comprises the first capacitor.

7. The acoustic device of claim 1, wherein the ASIC comprises the first capacitor.

8. The acoustic device of claim 1, further comprising a second capacitor having a different capacitance from the first capacitor.

9. An acoustic device comprising:
an application specific integrated circuit (ASIC) pad;
a first motor operably connected to the ASIC pad via a first electrical path and having a first pad;
a second motor operably connected to the ASIC pad via a second electrical path and having a second pad;
a first capacitor within a first area located proximate to the ASIC pad, such that the first capacitor and the ASIC pad can be electrically connected.

10. The acoustic device of claim 9, further comprising a bond between the ASIC pad and the first capacitor that electrically connects the first capacitor with the first motor and the second motor.

11. The acoustic device of claim 9, further comprising a second capacitor within a second area located next to the ASIC pad, such that the second capacitor and the ASIC pad can be electrically connected, wherein the second capacitor has a capacitance different from the first capacitor.

12. The acoustic device of claim 9, further comprising a bond between the ASIC pad and the second capacitor that electrically connects the first capacitor with the first motor and the second motor.

13. The acoustic device of claim 9, further comprising an ASIC electrically connected to the ASIC pad.

14. The acoustic device of claim 13, wherein the ASIC is a preamplifier.

15. The acoustic device of claim 9, further comprising a charge pump electrically connected to the first pad.

16. The acoustic device of claim 15, wherein the charge pump is electrically connected to the second pad.

17. A method of making an acoustic device comprising:
providing a substrate having a port;
attaching a microelectromechanical system (MEMS) that converts sound energy into electrical energy to the substrate;
attaching an application specific integrated circuit (ASIC) to the MEMS;
forming a first electrical path that connects the ASIC to the MEMS;
determining a sensitivity response of the MEMS;
providing a bond that connects a first capacitor to the first electrical path based upon the sensitivity response of the MEMS.

18. The method of claim 17, further comprising:
determining to provide the bond to connect the first capacitor to the first electrical path based on the sensitivity response of the MEMS; and
determining to avoid an electrical connection between the first electrical path and a second capacitor based upon the sensitivity response of the MEMS, wherein the first capacitor has a different capacitance compared to the second capacitor.

19. The method of claim 17, wherein the providing the bond decreases sensitivity of the MEMS.

20. The method of claim 18, wherein the capacitance of the first capacitor is smaller than the capacitance of the second capacitor, and the first capacitor connected to the first electrical path improves performance of the ASIC.
